(19) United States
(12) Patent Application Publication
(10) Pub. No.: US 2023/0317051 A1
(43) Pub. Date: Oct. 5, 2023

(54) ASYMMETRICAL ACOUSTIC HORN

(71) Applicant: Dolby Laboratories Licensing Corporation, San Francisco, CA (US)

(72) Inventors: Joel A. BUTLER, San Francisco, CA (US); Garth Norman SHOWALTER, San Francisco, CA (US); Brian RUFF, Olathe, KS (US); Mario DI COLA, Casoli (IT)

(73) Assignee: Dolby Laboratories Licensing Corporation, San Francisco, CA (US)

(21) Appl. No.: 18/008,434

(22) PCT Filed: Jun. 10, 2021
(86) PCT No.: PCT/US2021/036869

§ 371 Date: Dec. 5, 2022

Related U.S. Application Data
(60) Provisional application No. 63/037,277, filed on Jun. 10, 2020.

(30) Foreign Application Priority Data
Jun. 10, 2020 (EP) 20179169.6

(51) Int. Cl. G10K 11/26; G10K 11/02; H04R 1/34

(52) U.S. Cl. CPC G10K 11/26; G10K 11/02; H04R 1/345

(57) ABSTRACT

In one embodiment, there is provided an asymmetrical acoustic horn. The asymmetrical acoustic horn includes a single acoustic waveguide. The single acoustic waveguide includes a first asymmetrical horn section configured to support one or more first acoustic transducers, and a second asymmetrical horn section configured to support one or more second acoustic transducers, the one or more second acoustic transducers having a different frequency range than the one or more first acoustic transducers. The first asymmetrical horn section and the second asymmetrical horn section are contiguous with each other and are configured to separate respective ones of the one or more first acoustic transducers from corresponding ones of the one or more second acoustic transducers by a corresponding one or more predetermined and fixed distances.

### CROSS-REFERENCE TO RELATED APPLICATION

This application claims priority of the following priority applications: US provisional application 63/037,277, filed 10 Jun. 2020 and EP application 20179169.6, filed 10 June.2020.

### BACKGROUND

### 1. Field of the Disclosure

This application relates generally to acoustic horns.

### 2. Description of Related Art

It is often desirable to shape the acoustic radiation pattern of a loudspeaker to direct the acoustic energy at a desired target or audience region using shaped horns. These horns typically have an entry point where a single transducer can acoustically excite the air entering the horn, followed by a throat region with a nominal acoustic impedance, and an exit region wherein the radiating wave-front exits the horn. In some comparative examples, these horns are designed with rectangular acoustic radiation patterns, such as a 90° horizontal and 40° vertical pattern.

### SUMMARY

In one aspect of the present disclosure, there is provided an asymmetrical acoustic horn. The asymmetrical acoustic horn includes a single acoustic waveguide. The single acoustic waveguide a first asymmetrical horn section configured to support one or more first acoustic transducers, and a second asymmetrical horn section configured to support one or more second acoustic transducers, the one or more second acoustic transducers having a different frequency range than the one or more first acoustic transducers. The first asymmetrical horn section and the second asymmetrical horn section are contiguous with each other and are configured to separate respective ones of the one or more first acoustic transducers from corresponding ones of the one or more second acoustic transducers by a corresponding one or more predetermined and fixed distances.

In another aspect of the present disclosure, there is provided a loudspeaker. The loudspeaker includes one or more first acoustic transducers, one or more second acoustic transducers, and an asymmetrical acoustic horn. The asymmetrical acoustic horn includes a single acoustic waveguide. The single acoustic waveguide a first asymmetrical horn section configured to support one or more first acoustic transducers, and a second asymmetrical horn section configured to support one or more second acoustic transducers, the one or more second acoustic transducers having a different frequency range than the one or more first acoustic transducers. The first asymmetrical horn section and the second asymmetrical horn section are contiguous with each other and are configured to separate respective ones of the one or more first acoustic transducers from corresponding ones of the one or more second acoustic transducers by a corresponding one or more predetermined and fixed distances.

In yet another aspect of the present disclosure, there is provided a method. The method includes outputting, with one or more first acoustic transducers, first acoustic energy into a first asymmetrical horn section of an asymmetrical acoustic horn having a single acoustic waveguide. The method includes outputting, with one or more second acoustic transducers, second acoustic energy into a second asymmetrical horn section of the asymmetrical acoustic horn in parallel to the first acoustic energy into the first asymmetrical horn section of the asymmetrical acoustic horn. The method also includes outputting, with the asymmetrical acoustic horn, a first asymmetrical radiation pattern from the first asymmetrical horn section and a second asymmetrical radiation pattern from the second asymmetrical horn section. The first asymmetrical horn section and the second asymmetrical horn section are contiguous with each other and are configured to separate respective ones of the one or more first acoustic transducers from corresponding ones of the one or more second acoustic transducers by a corresponding one or more predetermined and fixed distances.

According to one or more of the above-described aspects of the present disclosure, there is provided more even acoustic radiation distribution across an audience plane, especially in a stadium seating acoustic environment. In this manner, various aspects of the present disclosure provide for improvements in at least the technical fields of acoustic radiation pattern control.

### DESCRIPTION OF THE DRAWINGS

The patent or application file contains at least one drawing executed in color. Copies of this patent or patent application publication with color drawing(s) will be provided by the Office upon request and payment of the necessary fee.

These and other more detailed and specific features of various embodiments are more fully disclosed in the following description, reference being had to the accompanying drawings, in which:

FIG. 1 is a diagram illustrating a side view of an example of an asymmetrical dual-entrant acoustic horn, according to various aspects of the present disclosure;

FIG. 2 is a diagram illustrating a perspective view of the asymmetrical dual-entrant acoustic horn, according to various aspects of the present disclosure;

FIG. 3 is a diagram illustrating a front view of an example of an acoustic radiation pattern output by the asymmetrical dual-entrant acoustic horn of FIGS. 1 and 2, according to various aspects of the present disclosure;

FIG. 4 is a diagram illustrating a perspective view of the acoustic radiation pattern output by the asymmetrical dual-entrant acoustic horn of FIGS. 1 and 2, according to various aspects of the present disclosure;

FIG. 5 is a diagram illustrating an example of an acoustic radiation pattern output by the asymmetrical dual-entrant acoustic horn of FIGS. 1 and 2 relative to stadium seating, according to various aspects of the present disclosure;

FIG. 6 is a heat map illustrating an example of a 1 kHz acoustic energy distribution output by the asymmetrical dual-entrant acoustic horn of FIGS. 1 and 2 relative to an audience plane, according to various aspects of the present disclosure;

FIG. 7 is a heat map illustrating an example of a 10 kHz acoustic energy distribution output by the asymmetrical dual-entrant acoustic horn of FIGS. 1 and 2 relative to the audience plane, according to various aspects of the present disclosure;

FIG. 8 is a diagram illustrating a front view of an example of a comparative acoustic radiation pattern output by an example comparative symmetrical acoustic horn;

FIG. 9 is a diagram illustrating a perspective view of the comparative acoustic radiation pattern output by the comparative symmetrical acoustic horn;

FIG. 10 is a diagram illustrating an example of an acoustic radiation pattern output by the comparative symmetrical acoustic horn relative to stadium seating;

FIG. 11 is a heat map illustrating an example of a 1 kHz acoustic energy distribution output by the comparative symmetrical acoustic horn relative to an audience plane;

FIG. 12 is a heat map illustrating an example of a 10 kHz acoustic energy distribution output by the comparative symmetrical acoustic horn relative the audience plane;

FIG. 13 is a table illustrating differences between the asymmetrical dual-entrant acoustic horn of FIGS. 1 and 2 and conventional acoustic horns, according to various aspects of the present disclosure; and

FIG. 14 is a flowchart illustrating an example method.

### DETAILED DESCRIPTION

This disclosure and aspects thereof can be embodied in various forms, including hardware or other structures controlled by computer-implemented methods, computer program products, computer systems and networks, user interfaces, and application programming interfaces; as well as hardware-implemented methods, signal processing circuits, memory arrays, application specific integrated circuits, field programmable gate arrays, and the like. The foregoing summary is intended solely to give a general idea of various aspects of the present disclosure, and does not limit the scope of the disclosure in any way.

In the following description, numerous details are set forth, such as geometries, dimensions, operations, and the like, in order to provide an understanding of one or more aspects of the present disclosure. It will be readily apparent to one skilled in the art that these specific details are merely examples and not intended to limit the scope of this application.

Horns that are designed with rectangular acoustic radiation patterns, such as a 90° horizontal and 40° vertical pattern, are typically set up for a single transducer entry point and provides the stated rectangular coverage pattern over a portion of the transducer's usable frequency range. However, the rectangular coverage pattern makes it difficult to achieve wide-band coverage control without using multiple separate horns.

Additionally, there are cases where one may wish to have non-rectangular pattern control to better focus the acoustic energy over a target audience region, where said audience region may vary greatly in distance and relative angle from the radiating horn source. For example, in a typical cinematic exhibition space using raked stadium seating, the front row of the audience is very close to the screen loudspeakers and positioned at an angle below the loudspeakers, whereas the back row of the audience space is much further away and located at an angle above the screen loudspeakers. Using a traditional rectangular radiating horn, such as the 90° by 40° horn mentioned above, within the cinematic space described above, will result in uneven acoustic energy distribution over the audience region. It should also be noted that this type of poor coverage control cannot be easily solved with equalization, as the resulting equalized solution may only be applied to a specific region within the audience space.

As a result of the problems associated with the aforementioned rectangular horns, the present disclosure seeks to provide a single acoustic horn that supports two or more transducer entry points and asymmetrical radiation pattern control over a portion of both transducer's usable frequency ranges to provide more uniform acoustic coverage over a target audience region that may be positioned at varying distances and angles relative to the horn. A radiation pattern is considered “asymmetrical” if the radiation pattern has a shape that is not symmetric about a plane extending in a horizontal direction.

This acoustic horn of the present disclosure is referred to as “an asymmetrical dual-entrant acoustic horn.” In particular, the asymmetrical dual-entrant acoustic horn is operable to provide asymmetrical acoustic radiation pattern control using two or more transducer entry points that acoustically sum in the region of excitation overlap. The asymmetrical dual-entrant acoustic horn includes a mechanical structure with an asymmetrical shape that supports two or more transducer excitation entry points, and a unified air pressure exit point.

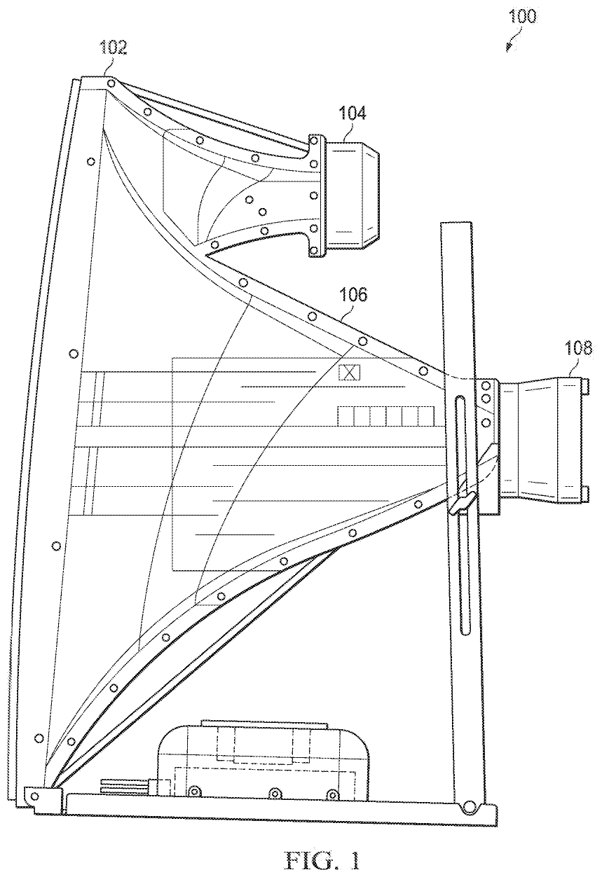

FIG. 1 is a diagram illustrating a side view of an example of an asymmetrical dual-entrant acoustic horn 100, according to various aspects of the present disclosure. In the example of FIG. 1, the asymmetrical dual-entrant acoustic horn 100 may have a continuous structure including a high-frequency asymmetrical horn section 102 integrated with a mid-frequency asymmetrical horn section 106 to form the asymmetrical dual-entrant horn 100.

The high-frequency asymmetrical horn section 102 is configured to removably attach to and support one or more high-frequency transducers 104. The one or more high-frequency transducers 104 are configured to generate acoustic energy at a frequency between 10 kilohertz (kHz) and 20 kHz.

Similarly, the mid-frequency asymmetrical horn section 106 is configured to removably attach to and support one or more mid-frequency transducers 108. The one or more mid-frequency transducers 108 are configured to generate acoustic energy at a frequency between 1 kilohertz (kHz) and 10 kHz.

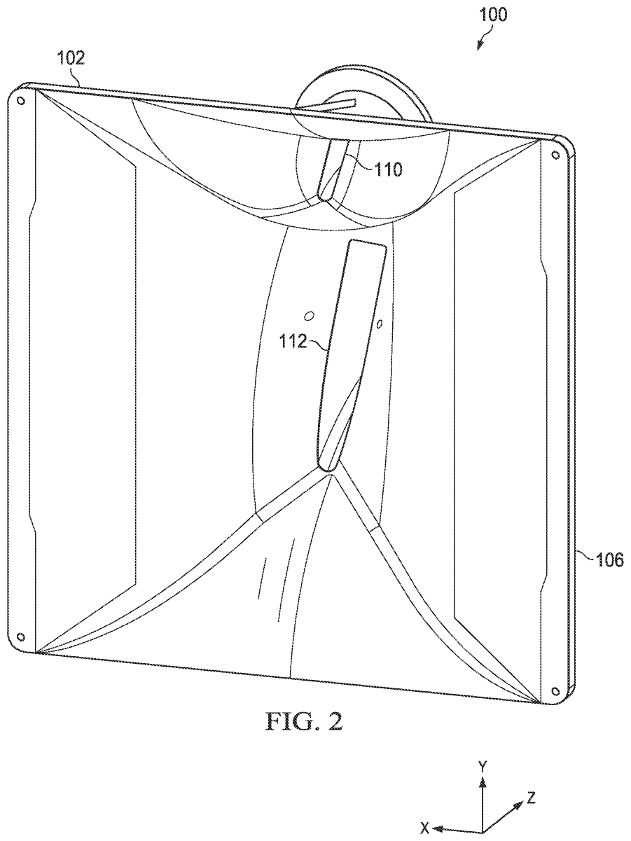

FIG. 2 is a diagram illustrating a perspective view of the asymmetrical dual-entrant acoustic horn 100 of FIG. 1, according to various aspects of the present disclosure. In the example of FIG. 2, the high-frequency asymmetrical horn section 102 includes a high-frequency diffraction slot 110 and the mid-frequency asymmetrical horn section 106 includes a mid-frequency diffraction slot 112.

As illustrated in FIG. 2, the high-frequency asymmetrical horn section 102 is integrated with the mid-frequency asymmetrical horn section 106 at a position where a comparative example symmetrical mid-frequency horn would experience acoustic energy output at the highest frequency. Specifically, the high-frequency diffraction slot 110 is positioned above the mid-frequency diffraction slot 112 in the Y direction. Additionally, the high-frequency asymmetrical horn section 102 and the mid-frequency asymmetrical horn section 106 are combined to form a unified air pressure exit point.

The high-frequency asymmetrical horn section 102 and the mid-frequency asymmetrical horn section 106 use one or more diffraction slots and constant directivity design techniques to control the acoustic radiation output by the asymmetrical dual-entrant acoustic horn 100. As illustrated in FIG. 2, the high-frequency asymmetrical horn section 102 of the asymmetrical dual-entrant acoustic horn 100 is positioned within the top of the mid-frequency asymmetrical horn section 106, just outside of the mid-frequency diffraction slot 112.

In some examples, assuming a cross-section of the asymmetrical dual-entrant acoustic horn 100 along a plane that traverses both the mid-frequency diffraction slot 112 and the high-frequency diffraction slot 110, the mid-frequency asymmetrical horn section 106 may have a maximum length in the Z-direction of approximately 500 millimeters (mm) from an edge of the throat section (i.e., an origin) associated with the mid-frequency asymmetrical horn section 106 to an edge of the unified air pressure exit point associated with the mid-frequency asymmetrical horn section 106. Comparatively, in these examples, the high-frequency asymmetrical horn section 102 may have a maximum length in the Z-direction of approximately 433 mm from the origin to an edge of the unified air pressure exit point associated with the high-frequency asymmetrical horn section 102, and a length in Z-direction of approximately 253 mm from an edge of a throat section associated with the high-frequency asymmetrical horn section 102 to the edge of the unified air pressure exit point associated with the high-frequency asymmetrical horn section 102.

In some examples, assuming a cross-section of the asymmetrical dual-entrant acoustic horn 100 along a plane that traverses both the mid-frequency diffraction slot 112 and the high-frequency diffraction slot 110, the mid-frequency asymmetrical horn section 106 may have a length in the Y-direction of approximately 381 millimeters (mm) from a centerline through the throat section (i.e., an origin) associated with the mid-frequency asymmetrical horn section 106 to an outer edge of the unified air pressure exit point associated with the mid-frequency asymmetrical horn section 106. Comparatively, in these examples, the high-frequency asymmetrical horn section 102 may have a length in the Y-direction of approximately 378 mm from the origin to an edge of the unified air pressure exit point associated with the high-frequency asymmetrical horn section 102.

In some examples, assuming a cross-section of the asymmetrical dual-entrant acoustic horn 100 along a plane that traverses both the mid-frequency diffraction slot 112 and the high-frequency diffraction slot 110, the mid-frequency asymmetrical horn section 106 may have an outer horn wall length that extends from an edge of the throat section associated with the mid-frequency asymmetrical horn section 106 to an outer edge of the unified air pressure exit point associated with the mid-frequency asymmetrical horn section 106 in the Y-direction of approximately 356 millimeters (mm). Comparatively, in these examples, the high-frequency asymmetrical horn section 102 has an outer horn wall length that extends from an edge of the throat section associated with the high-frequency asymmetrical horn section 102 to an outer edge of the unified air pressure exit point associated with the high-frequency asymmetrical horn section 102 in the Y-direction of approximately 108 millimeters (mm).

In some examples, assuming a cross-section of the asymmetrical dual-entrant acoustic horn 100 along a plane that traverses both the mid-frequency diffraction slot 112 and the high-frequency diffraction slot 110, the mid-frequency asymmetrical horn section 106 may have an inner horn wall length that extends from the edge of the throat section associated with the mid-frequency asymmetrical horn section 106 to an inner edge of the unified air pressure exit point associated with the mid-frequency asymmetrical horn section 106 in the Y-direction of approximately 160 millimeters (mm). Comparatively, in these examples, the high-frequency asymmetrical horn section 102 has an inner horn wall length that extends from an edge of the throat section associated with the high-frequency asymmetrical horn section 102 to an inner edge of the unified air pressure exit point associated with the high-frequency asymmetrical horn section 102 in the Y-direction of approximately 43 millimeters (mm).

As illustrated in FIGS. 1 and 2, the mid-frequency asymmetrical horn section 106 and the high-frequency asymmetrical horn section 102 are contiguous with each other because the inner horn wall of the mid-frequency asymmetrical horn section 106 is physically joined with the inner horn wall of the high-frequency asymmetrical horn section 102.

While FIGS. 1 and 2 illustrate an example asymmetrical acoustic horn 100 which includes only one high-frequency transducer 104 and only one mid-frequency transducer 108, the present disclosure is not so limited. In some examples of the present disclosure, the acoustic horn 100 may include more than one high-frequency transducer 104 and/or more than one mid-frequency transducer 108.

Additionally, while FIGS. 1 and 2 illustrate an example asymmetrical acoustic horn 100 having a continuous structure, the present disclosure is not so limited. In some examples of the present disclosure, the acoustic horn 100 may include several structural sub-components of the same or similar material that are mechanically affixed together to form a single unitary structure of substantially the same or similar material. For example, the high-frequency asymmetrical horn section 102 and the mid-frequency horn section 106 may be structural sub-components that may be mechanically affixed together to form a single unitary acoustic horn structure that is acoustically continuous, but the single unitary acoustic horn structure is necessarily structurally continuous.

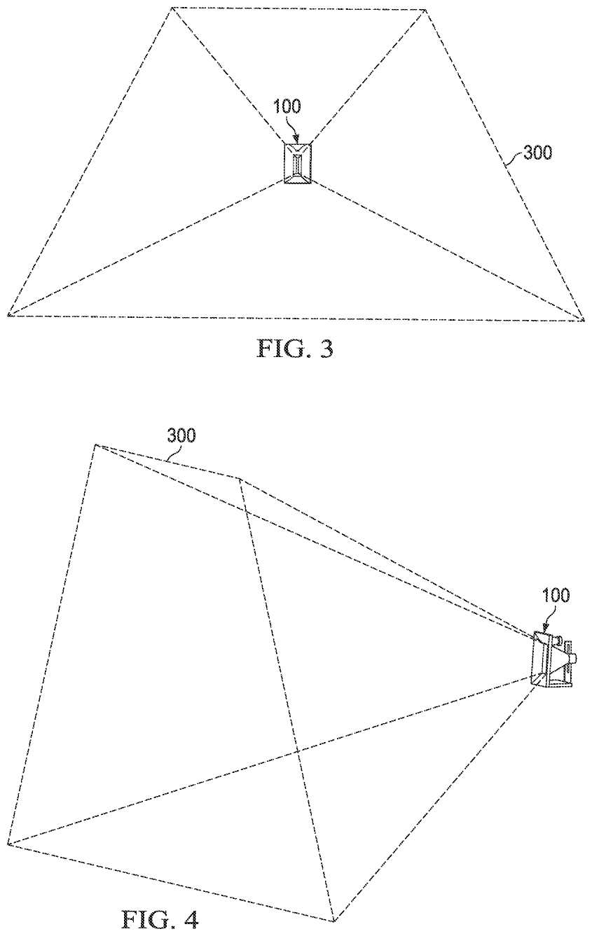

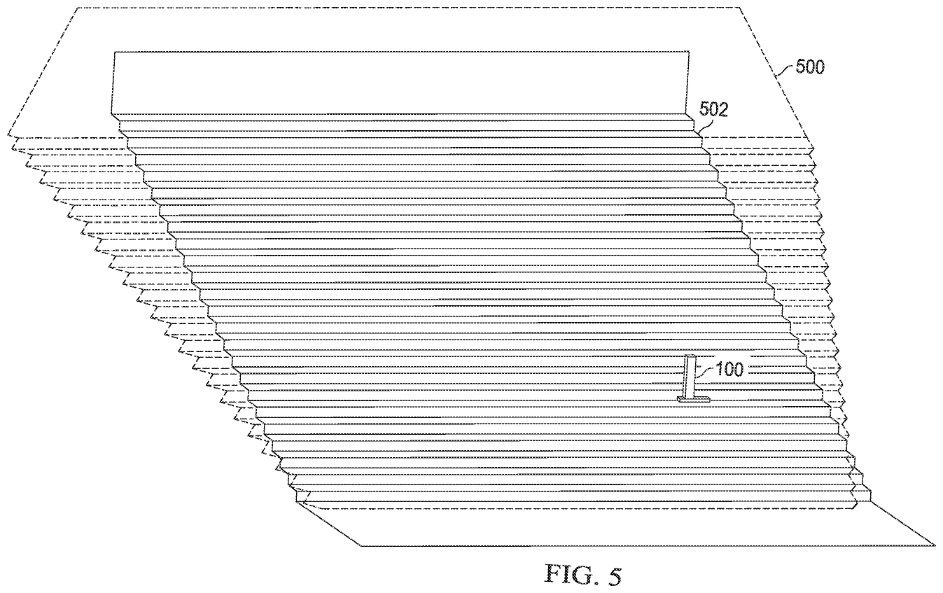

FIG. 3 is a diagram illustrating a front view of an example of an acoustic radiation pattern 300 output by the mid-frequency diffraction slot 112 of FIG. 2, according to various aspects of the present disclosure. FIG. 4 is a diagram illustrating a perspective view of the acoustic radiation pattern 300 output by the mid-frequency diffraction slot 112 of FIG. 2, according to various aspects of the present disclosure. As illustrated in FIGS. 3 and 4, the asymmetrical dual-entrant acoustic horn 100 outputs the acoustic radiation pattern 300 in a shape of a trapezoid from the mid-frequency diffraction slot 112 after receiving acoustic energy from the one or more mid-frequency transducers 108.

A similarly trapezoidal acoustic radiation pattern is output by the high-frequency diffraction slot 110. However, the acoustic radiation pattern output by the high-frequency diffraction slot 110 is smaller than the acoustic radiation pattern 300 because the high-frequency diffraction slot 110 is smaller than the mid-frequency diffraction slot 112.

In other words, the horizontal radiation patterns of the high-frequency diffraction slot 110 and the mid-frequency diffraction slot 112 provide for wider dispersion at the bottom of the horn exit, and narrower dispersion at the top of the horn exit. In this manner, the asymmetrical dual-entrant acoustic horn 100 may provide an improved listening experience for applications wherein the audience members sitting near the asymmetrical dual-entrant acoustic horn 100 are positioned below the horn exit and the audience members sitting far away from the horn are positioned above the horn exit, much like a cinematic stadium seating environment as illustrated as stadium seating 502 in FIG. 5. Thus, the horizontal radiation patterns are asymmetric as measured from the bottom to the top of the horn exit. The vertical radiation patterns of the asymmetrical dual-entrant acoustic horn 100 is typically not asymmetrical, but designed for a nominal fixed vertical coverage angle.

FIG. 5 is a diagram illustrating an example of an acoustic radiation pattern 500 output by the asymmetrical dual-entrant acoustic horn 100 of FIGS. 1 and 2 relative to stadium seating 502, according to various aspects of the present disclosure. Although a single acoustic radiation pattern 500 is illustrated in FIG. 5, the single acoustic radiation pattern 500 includes the acoustic radiation pattern 300 as illustrated in FIGS. 3 and 4 as a first radiation pattern that at least partially overlaps the acoustic radiation pattern output by the high-frequency diffraction slot 110 as a second radiation pattern.

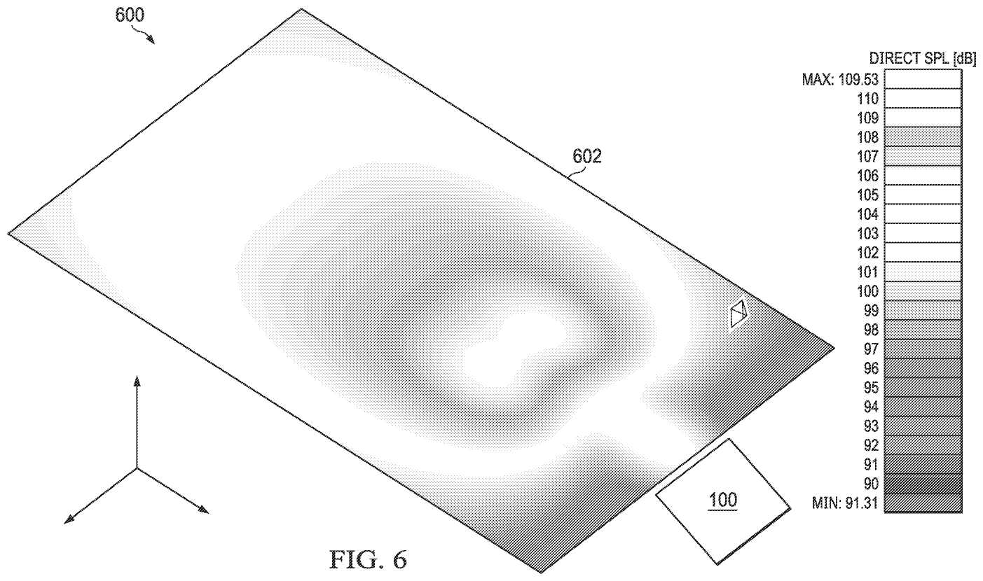

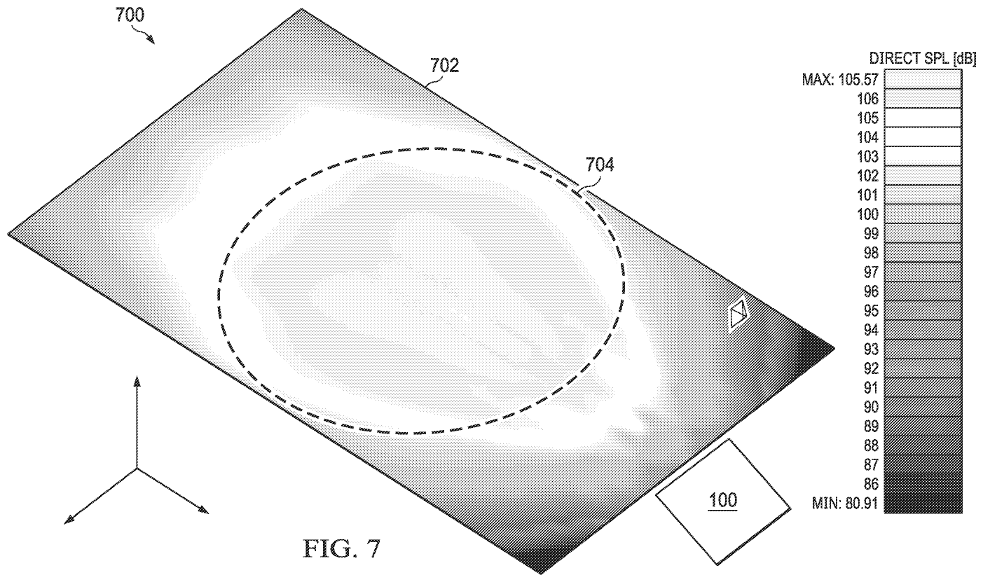

While these two radiation patterns may overlap, the single acoustic radiation pattern 500 substantially covers the entirety of the stadium seating 502 (e.g., as evidence by FIGS. 6 and 7). Moreover, interference from the overlap between the first radiation pattern and the second radiation pattern may be mitigated by acoustic processing based on the fixed distance between the high-frequency diffraction slot 110 and the mid-frequency diffraction slot 112. Additionally, interference from the overlap between the first radiation pattern and the second radiation pattern may also be mitigated by the structural designs of the high-frequency asymmetrical horn section 102 and the mid-frequency asymmetrical horn section 106.

FIG. 6 is a heat map illustrating an example of a 1 kHz acoustic energy distribution 600 output by the asymmetrical dual-entrant acoustic horn 100 of FIGS. 1 and 2 relative to an audience plane 602, according to various aspects of the present disclosure. As illustrated by FIG. 6, the example 1 kHz acoustic energy distribution 600 is evenly distributed over the audience plane 602 with an average direct sound pressure level (SPL) of 100.42 decibels (dB) between a maximum of 109.56 dB and a minimum of 91.31 dB. Additionally, as illustrated by FIG. 6, the only portion of the example 1 kHz acoustic energy distribution 600 that is below the average SPL is directly to the front left and to the front right of the asymmetrical dual-entrant acoustic horn 100.

FIG. 7 is a heat map illustrating an example of a 10 kHz acoustic energy distribution 700 output by the asymmetrical dual-entrant acoustic horn 100 of FIGS. 1 and 2 relative to an audience plane 702, according to various aspects of the present disclosure. As illustrated by FIG. 7, the example 10 kHz acoustic energy distribution 700 is evenly distributed over a central portion 704 of the audience plane 702 with an average direct SPL of 93.24 decibels (dB) between a maximum of 105.57 dB and a minimum of 80.91 dB. Additionally, as illustrated by FIG. 7, the only portion of the example 10 kHz acoustic energy distribution 700 that is below the average SPL is directly to the front left and to the front right of the asymmetrical dual-entrant acoustic horn 100.

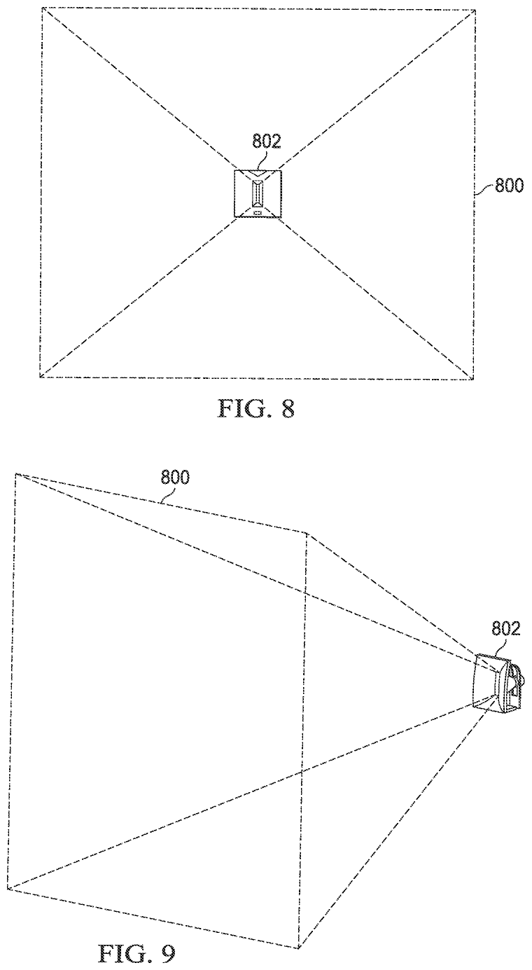

FIG. 8 is a diagram illustrating a front view of an example of a comparative acoustic radiation pattern 800 output by an example comparative symmetrical acoustic horn 802. FIG. 9 is a diagram illustrating a perspective view of the acoustic radiation pattern 800 output by the comparative symmetrical acoustic horn 802. As illustrated in FIGS. 8 and 9, the comparative dual-entrant acoustic horn 802 outputs the acoustic radiation pattern 800 in a shape of a square after receiving energy from a single transducer.

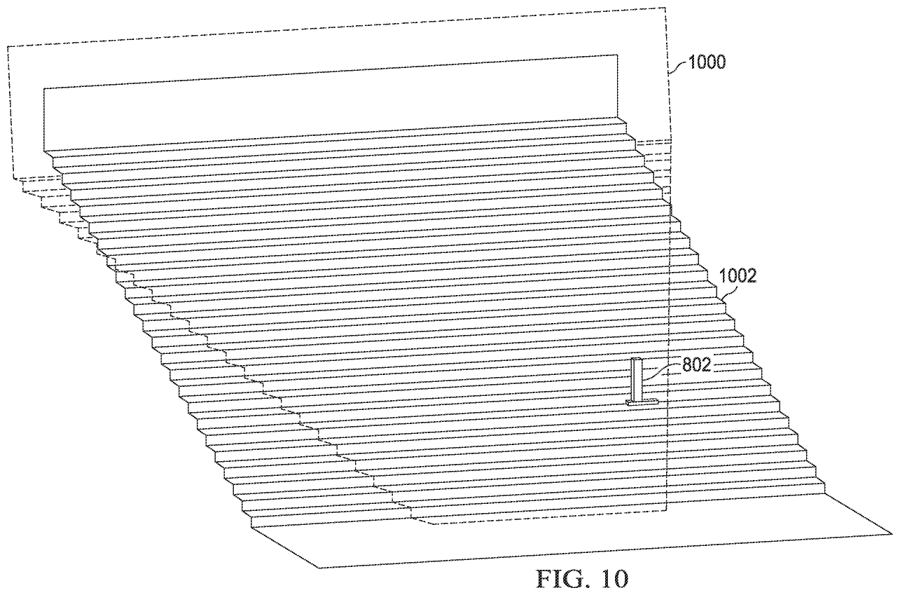

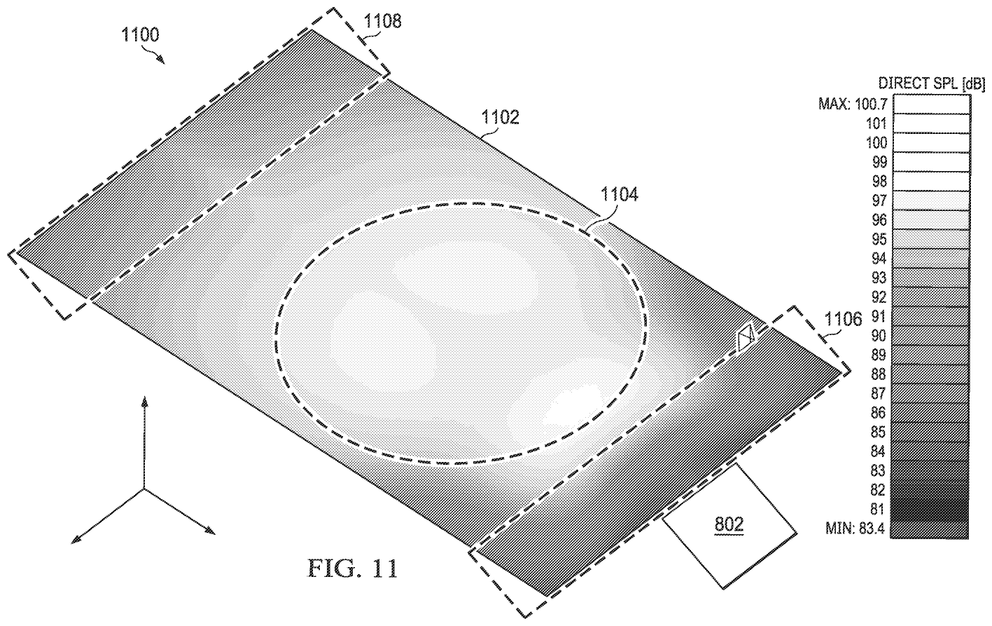

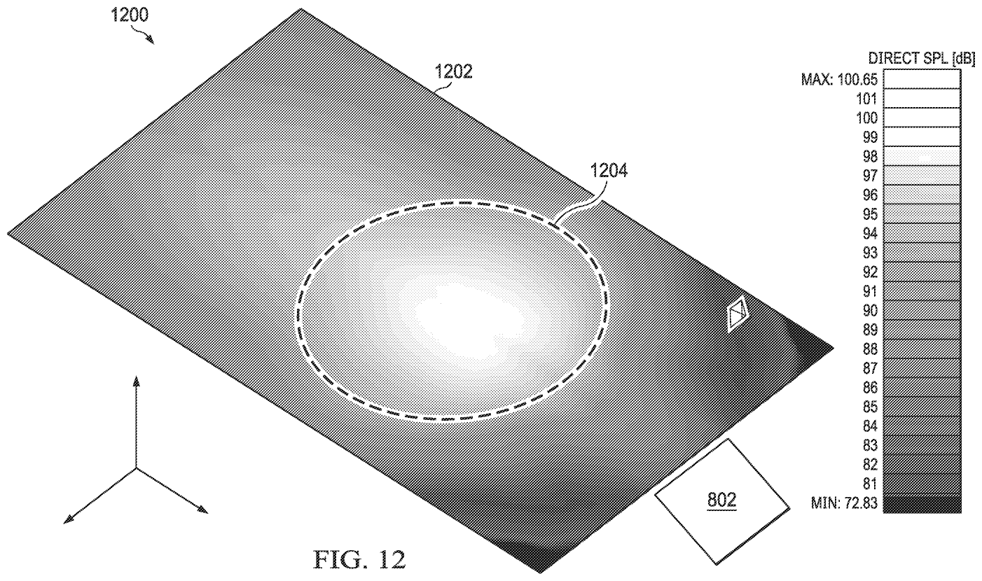

FIG. 10 is a diagram illustrating an example of an acoustic radiation pattern 1000 output by the comparative symmetrical acoustic horn 802 relative to stadium seating 1002. As illustrated in FIG. 10, the acoustic radiation pattern 1000 does not substantially cover the entirety of the stadium seating 1002 (e.g., as evidenced by FIGS. 11 and 12).

FIG. 11 is a heat map illustrating an example of a 1 kHz acoustic energy distribution 1100 output by the comparative symmetrical acoustic horn 802 relative to an audience plane 1102. As illustrated by FIG. 11, the example 1 kHz acoustic energy distribution 1100 is only evenly distributed over a central portion 1104 of the audience plane 1102 with an average direct SPL of 92.05 decibels (dB) between a maximum of 100.7 dB and a minimum of 83.4 dB. Moreover, as illustrated by FIG. 11, several portions of the example 1 kHz acoustic energy distribution 1100 that are below the average SPL. For example, a front portion 1106 and a rear portion 1108 relative to the comparative symmetrical acoustic horn 802 are below the average SPL.

FIG. 12 is a heat map illustrating an example of a 10 kHz acoustic energy distribution 1200 output by the comparative symmetrical acoustic horn 802 relative to the audience plane 1202. As illustrated by FIG. 12, the example 10 kHz acoustic energy distribution 1200 is only evenly distributed over a central portion 1204 of the audience plane 1202 with an average direct SPL of 86.74 decibels (dB) between a maximum of 100.65 dB and a minimum of 72.83 dB. Additionally, as illustrated by FIG. 12, the only portion of the example 10 kHz acoustic energy distribution 700 that is well above the average SPL is the central portion 1204.

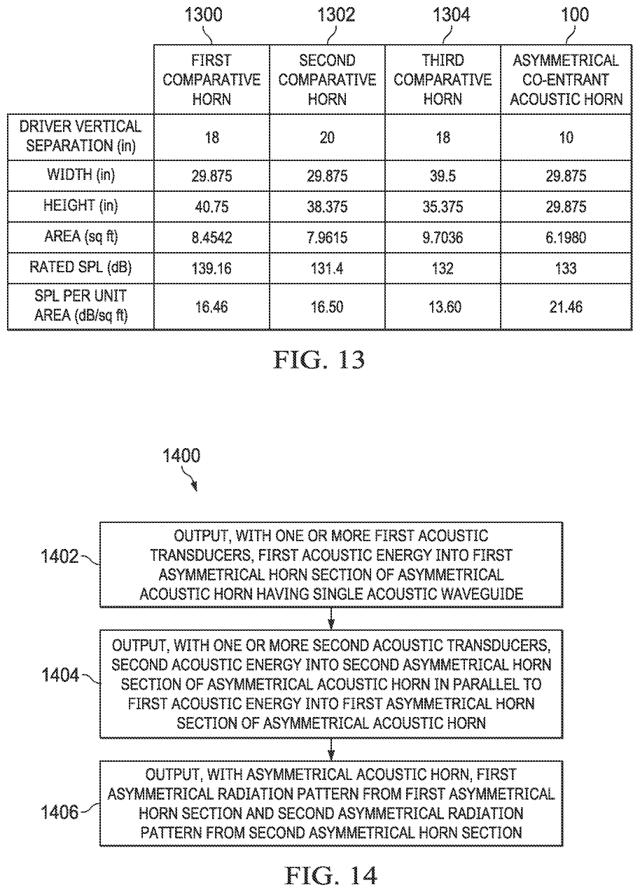

FIG. 13 is a table illustrating differences between the asymmetrical dual-entrant acoustic horn 100 of FIGS. 1 and 2 and comparative acoustic horns, according to various aspects of the present disclosure.

As illustrated in FIG. 13, the asymmetrical dual-entrant acoustic horn 100 has a driver vertical separation (i.e., the Y direction of FIG. 2) of approximately 10 inches, a width of approximately 29.875 inches, a height of approximately 29.875 inches, and an area of approximately 6.1980 square feet. The asymmetrical dual-entrant acoustic horn 100 also has a Rated SPL of 133 dB and an SPL per unit area of approximately 21.46 dB per square feet.

As illustrated in FIG. 13, a first comparative acoustic horn 1300 has a driver vertical separation of approximately 18 inches, a width of approximately 29.875 inches, a height of approximately 40.75 inches, and an area of approximately 8.4542 square feet. The first comparative acoustic horn 1300 also has a Rated SPL of 139.16 dB and an SPL per unit area of approximately 16.46 dB per square feet. The first comparative acoustic horn 1300 is, for example, acoustic horn model number 3732-M/HF or acoustic horn model number 5732-M/HF produced by JBL of Los Angeles, California.

As illustrated in FIG. 13, a second comparative acoustic horn 1302 has a driver vertical separation of approximately 20 inches, a width of approximately 29.875 inches, a height of approximately 38.375 inches, and an area of approximately 7.9615 square feet. The second comparative acoustic horn 1302 also has a Rated SPL of 131.4 dB and an SPL per unit area of approximately 16.50 dB per square feet. The second comparative acoustic horn 1302 is, for example, acoustic horn model number MHV-1090 produced by QSC of Costa Mesa, California.

As illustrated in FIG. 13, a third comparative acoustic horn 1304 has a driver vertical separation of approximately 18 inches, a width of approximately 39.5 inches, a height of approximately 35.375 inches, and an area of approximately 9.7036 square feet. The third comparative acoustic horn 1304 also has a Rated SPL of 132 dB and an SPL per unit area of approximately 13.60 dB per square feet. The first comparative acoustic horn 1300 is, for example, acoustic horn model number KPT-535 produced by Klipsch of Indianapolis, Indiana.

In other words, the asymmetrical dual-entrant acoustic horn 100 is smaller than the first, second, and third comparative acoustic horns 1300-1304. Specifically, the asymmetrical dual-entrant acoustic horn 100 is 36.4%, 28.4%, and 56.56% smaller than the first, second, and third comparative acoustic horns 1300-1304, respectively. Further, the asymmetrical dual-entrant acoustic horn 100 provides for better acoustic energy distribution than comparative acoustic horns relative to stadium seating as illustrated in FIGS. 3-12 due to the asymmetrical structure of the high-frequency asymmetrical horn section 102 and the mid-frequency asymmetrical horn section 106.

FIG. 14 is a flowchart illustrating an example method 1400. FIG. 14 is described with respect to the asymmetrical dual-entrant acoustic horn 100 of FIGS. 1-4. The method 1400 includes outputting, with one or more first acoustic transducers, first acoustic energy into a first asymmetrical horn section of an asymmetrical acoustic horn having a single acoustic waveguide (at block 1402). For example, the high-frequency acoustic transducer 104 outputs first acoustic energy into a throat section of the high-frequency asymmetrical horn section 102.

The method 1400 includes outputting, with one or more second acoustic transducers, second acoustic energy into a second asymmetrical horn section of the asymmetrical acoustic horn in parallel to the first acoustic energy into the first asymmetrical horn section of the asymmetrical acoustic horn (at block 1404). For example, the mid-frequency acoustic transducer 108 outputs second acoustic energy into a throat section of the mid-frequency asymmetrical horn section 106.

The method 1400 also includes outputting, with the asymmetrical acoustic horn, a first asymmetrical radiation pattern from the first asymmetrical horn section and a second asymmetrical radiation pattern from the second asymmetrical horn section (at block 1406). For example, the asymmetrical dual-entrant acoustic horn 100 outputs a first trapezoidal acoustic radiation pattern 300 and a second trapezoidal acoustic radiation pattern.

As described above and illustrated in FIGS. 1 and 2, the first asymmetrical horn section and the second asymmetrical horn section are contiguous with each other. Additionally, the first asymmetrical horn section and the second asymmetrical horn section are configured to separate respective ones of the one or more first acoustic transducers from corresponding ones of the one or more second acoustic transducers by a corresponding one or more predetermined and fixed distances.

Acoustic horns, loudspeakers, and methods in accordance with the present disclosure may take any one or more of the following configurations.

(1) An asymmetrical acoustic horn comprising: a single acoustic waveguide including a first asymmetrical horn section configured to support one or more first acoustic transducers, and a second asymmetrical horn section configured to support one or more second acoustic transducers, the one or more second acoustic transducers having a different frequency range than the one or more first acoustic transducers, wherein the first asymmetrical horn section and the second asymmetrical horn section are contiguous with each other, and wherein the first asymmetrical horn section and the second asymmetrical horn section are configured to separate respective ones of the one or more first acoustic transducers from corresponding ones of the one or more second acoustic transducers by a corresponding one or more predetermined and fixed distances.
(2) The asymmetrical acoustic horn of (1), wherein the first asymmetrical horn section includes one or more first diffraction slots, and wherein the second asymmetrical horn section includes one or more second diffraction slots.
(3) The asymmetrical acoustic horn of (2), wherein a first diffraction slot of the one or more first diffraction slots is configured to receive acoustic energy from a first acoustic transducer of the one or more first acoustic transducers.
(4) The asymmetrical acoustic horn of any one of (2) or (3), wherein a second diffraction slot of the one or more second diffraction slots is configured to receive second acoustic energy from a second acoustic transducer of the one or more second acoustic transducers.
(5) The asymmetrical acoustic horn of any one of (1)-(4), wherein a predetermined and fixed distance between the first acoustic transducer and the second acoustic transducer is approximately ten inches.
(6) The asymmetrical acoustic horn of any one of (1)-(5), wherein the single acoustic waveguide has a width of approximately 29.875 inches, a height of approximately 29.875 inches, and an area of approximately 6.198 square feet.
(7) The asymmetrical acoustic horn of any one of (1)-(6), wherein the single acoustic waveguide has a rated sound pressure level (SPL) of approximately 133 decibels (dB) and an SPL per unit area of approximately 21.46 dB per square feet.
(8) The asymmetrical acoustic horn of any one of (1)-(7), wherein the first asymmetrical horn section is further configured to receive acoustic energy from the one or more first acoustic transducers, and output a trapezoidal acoustic radiation pattern.
(9). The asymmetrical acoustic horn of any one of (1)-(8), wherein the second asymmetrical horn section is further configured to receive acoustic energy from the one or more second acoustic transducers, and output a trapezoidal acoustic radiation pattern.
(10) A loudspeaker comprising: one or more first acoustic transducers; one or more second acoustic transducers; and an asymmetrical acoustic horn including a single acoustic waveguide including a first asymmetrical horn section configured to support the one or more first acoustic transducers, and a second asymmetrical horn section configured to support the one or more second acoustic transducers, the one or more second acoustic transducers having a different frequency range than the one or more first acoustic transducers, wherein the first asymmetrical horn section and the second asymmetrical horn section are contiguous with each other, and wherein the first asymmetrical horn section and the second asymmetrical horn section are configured to separate respective ones of the one or more first acoustic transducers from corresponding ones of the one or more second acoustic transducers by a corresponding one or more predetermined and fixed distances.
(11) The loudspeaker of (10), wherein the second one or more acoustic transducers have a higher frequency range than the one or more first acoustic transducers.
(12) The loudspeaker of (10) or (11), wherein a predetermined and fixed distance between the first acoustic transducer and the second acoustic transducer is approximately ten inches.
(13) The loudspeaker of any one of (10)-(12), wherein the single acoustic waveguide has a width of approximately 29.875 inches, a height of approximately 29.875 inches, and an area of approximately 6.198 square feet.
(14) The loudspeaker of any one of (10)-(13), wherein the single acoustic waveguide has a rated sound pressure level (SPL) of approximately 133 decibels (dB) and an SPL per unit area of approximately 21.46 dB per square feet.
(15) The loudspeaker of any one of (10)-(14), wherein the first asymmetrical horn section is further configured to receive acoustic energy from the one or more first acoustic transducers, and output a trapezoidal acoustic radiation pattern.
(16) The loudspeaker of (15), wherein the second asymmetrical horn section is further configured to receive second acoustic energy from the one or more second acoustic transducers, and output a second trapezoidal acoustic radiation pattern.
(17) The loudspeaker of (16), wherein a first perimeter of the first trapezoidal acoustic radiation pattern is wider at the bottom of the first perimeter than the top of the first perimeter along the Y-direction, and wherein a second perimeter of the second trapezoidal acoustic radiation pattern is wider at the bottom of the second perimeter than the top of the second perimeter along the Y-direction.
(18) A method comprising: outputting, with one or more first acoustic transducers, first acoustic energy into a first asymmetrical horn section of an asymmetrical acoustic horn having a single acoustic waveguide; outputting, with one or more second acoustic transducers, second acoustic energy into a second asymmetrical horn section of the asymmetrical acoustic horn in parallel to the first acoustic energy into the first asymmetrical horn section of the asymmetrical acoustic horn; and outputting, with the asymmetrical acoustic horn, a first asymmetrical radiation pattern from the first asymmetrical horn section and a second asymmetrical radiation pattern from the second asymmetrical horn section, wherein the first asymmetrical horn section and the second asymmetrical horn section are contiguous with each other, and wherein the first asymmetrical horn section and the second asymmetrical horn section are configured to separate respective ones of the one or more first acoustic transducers from corresponding ones of the one or more second acoustic transducers by a corresponding one or more predetermined and fixed distances.
(19). The method of (19), wherein the first asymmetrical radiation pattern is a first trapezoidal radiation pattern, and wherein the second asymmetrical radiation pattern is a second trapezoidal radiation pattern.
(20). A non-transitory computer-readable-medium storing instructions that, when executed by an electronic processor, cause the electronic processor to perform operations comprising the method of (18).

With regard to the devices, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments incorporate more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

Various aspects of the present invention may be appreciated from the following enumerated example embodiments (EEEs):

EEE1. An asymmetrical acoustic horn comprising:

a single acoustic waveguide including
a first asymmetrical horn section configured to support one or more first acoustic transducers, and
a second asymmetrical horn section configured to support one or more second acoustic transducers, the one or more second acoustic transducers having a different frequency range than the one or more first acoustic transducers,

wherein the first asymmetrical horn section and the second asymmetrical horn section are contiguous with each other, and

wherein the first asymmetrical horn section and the second asymmetrical horn section are configured to separate respective ones of the one or more first acoustic transducers from corresponding ones of the one or more second acoustic transducers by a corresponding one or more predetermined and fixed distances.

EEE2. The asymmetrical acoustic horn of EEE 1, wherein the first asymmetrical horn section includes one or more first diffraction slots, and wherein the second asymmetrical horn section includes one or more second diffraction slots.

EEE3. The asymmetrical acoustic horn of EEE 2, wherein a first diffraction slot of the one or more first diffraction slots is configured to receive acoustic energy from a first acoustic transducer of the one or more first acoustic transducers.

EEE4. The asymmetrical acoustic horn of EEE 2 or EEE 3, wherein a second diffraction slot of the one or more second diffraction slots is configured to receive second acoustic energy from a second acoustic transducer of the one or more second acoustic transducers.

EEE5. The asymmetrical acoustic horn of any of EEEs 1-4, wherein a predetermined and fixed distance between the first acoustic transducer and the second acoustic transducer is approximately ten inches.

EEE6. The asymmetrical acoustic horn of any of EEEs 1-5, wherein the single acoustic waveguide has a width of approximately 29.875 inches, a height of approximately 29.875 inches, and an area of approximately 6.198 square feet.

EEE7. The asymmetrical acoustic horn of any of EEEs 1-6, wherein the single acoustic waveguide has a rated sound pressure level (SPL) of approximately 133 decibels (dB) and an

SPL per unit area of approximately 21.46 dB per square feet.

EEE8. The asymmetrical acoustic horn of any of EEEs 1-7, wherein the first asymmetrical horn section is further configured to

receive acoustic energy from the one or more first acoustic transducers, and

output a first trapezoidal acoustic radiation pattern.

EEE9. The asymmetrical acoustic horn of any of EEEs 1-8, wherein the second asymmetrical horn section is further configured to

receive acoustic energy from the one or more second acoustic transducers, and

output a second trapezoidal acoustic radiation pattern.

EEE 10. The asymmetrical acoustic horn of EEEs 8 and 9, wherein a first perimeter of the first trapezoidal acoustic radiation pattern is wider at the bottom of the first perimeter than the top of the first perimeter along the Y-direction (such that the first trapezoidal radiation pattern is asymmetric as measured along a direction from a bottom to a top of an exit of the asymmetrical acoustic horn), and wherein a second perimeter of the second trapezoidal acoustic radiation pattern is wider at the bottom of the second perimeter than the top of the second perimeter along the Y-direction (such that the second trapezoidal radiation pattern is asymmetric as measured along the direction from the bottom to the top of the exit of the asymmetrical acoustic horn).

EEE11. The asymmetrical acoustic horn of any of EEEs 1-10, wherein the first asymmetrical horn section is configured to output a first asymmetrical radiation pattern and the second asymmetrical horn section is configured to output a second asymmetrical radiation pattern, the first and second asymmetrical radiation pattern having a shape that is not symmetric about a plane extending in a horizontal direction.

EEE12. The asymmetrical acoustic horn of EEE11, wherein the first asymmetrical radiation pattern is a first trapezoidal radiation pattern, and wherein the second asymmetrical radiation pattern is a second trapezoidal radiation pattern.

EEE13. A loudspeaker comprising:

one or more first acoustic transducers;

one or more second acoustic transducers; and

an asymmetrical acoustic horn including
a single acoustic waveguide including
a first asymmetrical horn section configured to support the one or more first acoustic transducers, and
a second asymmetrical horn section configured to support the one or more second acoustic transducers, the one or more second acoustic transducers having a different frequency range than the one or more first acoustic transducers,

wherein the first asymmetrical horn section and the second asymmetrical horn section are contiguous with each other, and

wherein the first asymmetrical horn section and the second asymmetrical horn section are configured to separate respective ones of the one or more first acoustic transducers from corresponding ones of the one or more second acoustic transducers by a corresponding one or more predetermined and fixed distances.

EEE14. The loudspeaker of EEE13, wherein the first asymmetrical horn section is configured to output a first asymmetrical radiation pattern and the second asymmetrical horn section is configured to output a second asymmetrical radiation pattern, the first and second asymmetrical radiation pattern having a shape that is not symmetric about a plane extending in a horizontal direction.

EEE15. The loudspeaker of EEE14, wherein the first asymmetrical horn section comprises a first diffraction slot configured to output the first asymmetrical radiation pattern as a first trapezoidal radiation pattern, and wherein the second asymmetrical horn section comprises a second diffraction slot configured to output the second asymmetrical radiation pattern as a second trapezoidal radiation pattern.

EEE16. The loudspeaker of EEE15, wherein the first and second asymmetrical radiation patterns output by the first and second diffraction slots provide for wider dispersion at a bottom of an exit of the acoustic horn exit, and narrower dispersion at a top of the exit of the horn.

EEE17. The loudspeaker of any of EEEs 13-16, wherein the second one or more acoustic transducers have a higher frequency range than the one or more first acoustic transducers.

EEE18. The loudspeaker of EEE17, wherein the first asymmetrical horn section is a mid-frequency asymmetrical horn section configured to support the one or more first acoustic transducers being one or more mid-frequency transducers, and the second asymmetrical horn section is a high-frequency asymmetrical horn section configured to support the one or more second acoustic transducers being one or more high-frequency transducers.

EEE19. The loudspeaker of EEE 18 when dependent on EEE15 or 16, wherein the first diffraction slot is a mid-frequency diffraction slot, and the second diffraction slot is a high-frequency diffraction slot positioned above the mid-frequency diffraction slot.

EEE20. The loudspeaker of any of EEEs 13-19, wherein a predetermined and fixed distance between the first acoustic transducer and the second acoustic transducer is approximately ten inches.

EEE21. The loudspeaker of any of EEEs 13-20, wherein the single acoustic waveguide has a width of approximately 29.875 inches, a height of approximately 29.875 inches, and an area of approximately 6.198 square feet.

EEE22. The loudspeaker of any of EEEs 13-21, wherein the single acoustic waveguide has a rated sound pressure level (SPL) of approximately 133 decibels (dB) and an SPL per unit area of approximately 21.46 dB per square feet.

EEE23. The loudspeaker of any of EEEs 13-22, wherein the first asymmetrical horn section is further configured to

receive acoustic energy from the one or more first acoustic transducers, and

output a first trapezoidal acoustic radiation pattern.

EEE24. The loudspeaker of any of EEEs 13-23, wherein the second asymmetrical horn section is further configured to

receive second acoustic energy from the one or more second acoustic transducers, and

output a second trapezoidal acoustic radiation pattern.

EEE25. The loudspeaker of EEE 23 and EEE 24, wherein a first perimeter of the first trapezoidal acoustic radiation pattern is wider at the bottom of the first perimeter than the top of the first perimeter along the Y-direction (such that the first trapezoidal radiation pattern is asymmetric as measured along a direction from a bottom to a top of an exit of the asymmetrical acoustic horn), and wherein a second perimeter of the second trapezoidal acoustic radiation pattern is wider at the bottom of the second perimeter than the top of the second perimeter along the Y-direction (such that the second trapezoidal radiation pattern is asymmetric as measured along the direction from the bottom to the top of the exit of the asymmetrical acoustic horn).

EEE26. A method comprising:

outputting, with one or more first acoustic transducers, first acoustic energy into a first asymmetrical horn section of an asymmetrical acoustic horn having a single acoustic waveguide;

outputting, with one or more second acoustic transducers, second acoustic energy into a second asymmetrical horn section of the asymmetrical acoustic horn in parallel to the first acoustic energy into the first asymmetrical horn section of the asymmetrical acoustic horn; and

outputting, with the asymmetrical acoustic horn, a first asymmetrical radiation pattern from the first asymmetrical horn section and a second asymmetrical radiation pattern from the second asymmetrical horn section,

wherein the first asymmetrical horn section and the second asymmetrical horn section are contiguous with each other, and

wherein the first asymmetrical horn section and the second asymmetrical horn section are configured to separate respective ones of the one or more first acoustic transducers from corresponding ones of the one or more second acoustic transducers by a corresponding one or more predetermined and fixed distances.

EEE27. The method of EEE26, wherein the first and second asymmetrical radiation pattern have a shape that is not symmetric about a plane extending in a horizontal direction.

EEE28. The method of any of EEE 26 or 27, wherein the first asymmetrical radiation pattern is a first trapezoidal radiation pattern, and wherein the second asymmetrical radiation pattern is a second trapezoidal radiation pattern.

EEE29. The method of EEE28, wherein the first trapezoidal radiation pattern is output by a first diffraction slot of the first asymmetrical horn section, and wherein the second trapezoidal radiation pattern is output by a second diffraction slot of the second asymmetrical horn section.

EEE30. The method of EEE29, wherein the first and second asymmetrical radiation patterns output by the first and second diffraction slots provide for wider dispersion at a bottom of an exit of the acoustic horn exit, and narrower dispersion at a top of the exit of the horn.

EEE31. The method of any of EEEs 26-30, wherein the one or more first acoustic transducers are mid-frequency transducers and the first asymmetrical horn section is a mid-frequency asymmetrical horn section, and wherein the one or more second acoustic transducers are high-frequency transducers and the second asymmetrical horn section is a high-frequency asymmetrical horn section.

EEE32. The method of EEE31 when dependent on EEE 29 or 30, wherein the first diffraction slot is a mid-frequency diffraction slot, and the second diffraction slot is a high-frequency diffraction slot positioned above the mid-frequency diffraction slot.

EEE33. A non-transitory computer-readable-medium storing instructions that, when executed by an electronic processor, cause the electronic processor to perform operations comprising the method of EEEs 26-32.

1. An asymmetrical acoustic horn comprising:
a single acoustic waveguide including
a first asymmetrical horn section configured to support one or more first acoustic transducers, and
a second asymmetrical horn section configured to support one or more second acoustic transducers, the one or more second acoustic transducers having a different frequency range than the one or more first acoustic transducers,
wherein the first asymmetrical horn section and the second asymmetrical horn section are contiguous with each other, and
wherein the first asymmetrical horn section and the second asymmetrical horn section are configured to separate respective ones of the one or more first acoustic transducers from corresponding ones of the one or more second acoustic transducers by a corresponding one or more predetermined and fixed distances.

2. The asymmetrical acoustic horn of claim 1, wherein the first asymmetrical horn section is configured to output a first asymmetrical radiation pattern and the second asymmetrical horn section is configured to output a second asymmetrical radiation pattern, the first and second asymmetrical radiation pattern having a shape that is not symmetric about a plane extending in a horizontal direction.

3. The asymmetrical acoustic horn of claim 2, wherein the first asymmetrical radiation pattern is a first trapezoidal radiation pattern, and wherein the second asymmetrical radiation pattern is a second trapezoidal radiation pattern.

4. The asymmetrical acoustic horn of claim 1, wherein the first asymmetrical horn section includes one or more first diffraction slots, and wherein the second asymmetrical horn section includes one or more second diffraction slots.

5. The asymmetrical acoustic horn of claim 4, wherein a first diffraction slot of the one or more first diffraction slots is configured to receive acoustic energy from a first acoustic transducer of the one or more first acoustic transducers.

6. The asymmetrical acoustic horn of claim 4, wherein a second diffraction slot of the one or more second diffraction slots is configured to receive second acoustic energy from a second acoustic transducer of the one or more second acoustic transducers.

7. The asymmetrical acoustic horn of claim 1, wherein a predetermined and fixed distance between the first acoustic transducer and the second acoustic transducer is approximately ten inches.

8. The asymmetrical acoustic horn of claim 1, wherein the single acoustic waveguide has a width of approximately 29.875 inches, a height of approximately 29.875 inches, and an area of approximately 6.198 square feet.

9. The asymmetrical acoustic horn of claim 1, wherein the single acoustic waveguide has a rated sound pressure level (SPL) of approximately 133 decibels (dB) and an SPL per unit area of approximately 21.46 dB per square feet.

10. The asymmetrical acoustic horn of claims 1, wherein the first asymmetrical horn section is further configured to
receive acoustic energy from the one or more first acoustic transducers, and
output a first trapezoidal acoustic radiation pattern.

11. The asymmetrical acoustic horn of claims 1, wherein the second asymmetrical horn section is further configured to
receive acoustic energy from the one or more second acoustic transducers, and
output a second trapezoidal acoustic radiation pattern.

12. The asymmetrical acoustic horn of claim 10, wherein a first perimeter of the first trapezoidal acoustic radiation pattern is wider at the bottom of the first perimeter than the top of the first perimeter such that the first trapezoidal radiation pattern is asymmetric as measured along a direction from a bottom to a top of an exit of the asymmetrical acoustic horn, and wherein a second perimeter of the second trapezoidal acoustic radiation pattern is wider at the bottom of the second perimeter than the top of the second perimeter such that the second trapezoidal radiation pattern is asymmetric as measured along the direction from the bottom to the top of the exit of the asymmetrical acoustic horn.

13. A loudspeaker comprising:
one or more first acoustic transducers;
one or more second acoustic transducers; and
an asymmetrical acoustic horn according to claim 1.

14. The loudspeaker of claim 13, wherein the first asymmetrical horn section is configured to output a first asymmetrical radiation pattern and the second asymmetrical horn section is configured to output a second asymmetrical radiation pattern, the first and second asymmetrical radiation pattern having a shape that is not symmetric about a plane extending in a horizontal direction.

15. The loudspeaker of claim 14, wherein the first asymmetrical horn section comprises a first diffraction slot configured to output the first asymmetrical radiation pattern as a first trapezoidal radiation pattern, and wherein the second asymmetrical horn section comprises a second diffraction slot configured to output the second asymmetrical radiation pattern as a second trapezoidal radiation pattern.

16. The loudspeaker of claim 15, wherein the first and second asymmetrical radiation patterns output by the first and second diffraction slots provide for wider dispersion at a bottom of an exit of the acoustic horn exit, and narrower dispersion at a top of the exit of the horn.

17. The loudspeaker of claim 13 wherein the second one or more acoustic transducers have a higher frequency range than the one or more first acoustic transducers.

18. The loudspeaker of claim 17, wherein the first asymmetrical horn section is a mid-frequency asymmetrical horn section configured to support the one or more first acoustic transducers being one or more mid-frequency transducers, and the second asymmetrical horn section is a high-frequency asymmetrical horn section configured to support the one or more second acoustic transducers being one or more high-frequency transducers.

19. (canceled)

20. A method comprising:
outputting, with one or more first acoustic transducers, first acoustic energy into a first asymmetrical horn section of an asymmetrical acoustic horn having a single acoustic waveguide;
outputting, with one or more second acoustic transducers, second acoustic energy into a second asymmetrical horn section of the asymmetrical acoustic horn in parallel to the first acoustic energy into the first asymmetrical horn section of the asymmetrical acoustic horn; and
outputting, with the asymmetrical acoustic horn, a first asymmetrical radiation pattern from the first asymmetrical horn section and a second asymmetrical radiation pattern from the second asymmetrical horn section,
wherein the first asymmetrical horn section and the second asymmetrical horn section are contiguous with each other, and
wherein the first asymmetrical horn section and the second asymmetrical horn section are configured to separate respective ones of the one or more first acoustic transducers from corresponding ones of the one or more second acoustic transducers by a corresponding one or more predetermined and fixed distances.

21. The method of claim 20, wherein the first and second asymmetrical radiation pattern have a shape that is not symmetric about a plane extending in a horizontal direction.

22. The method of claim 20, wherein the first asymmetrical radiation pattern is a first trapezoidal radiation pattern, and wherein the second asymmetrical radiation pattern is a second trapezoidal radiation pattern.

23. The method of claim 22, wherein the first trapezoidal radiation pattern is output by a first diffraction slot of the first asymmetrical horn section, and wherein the second trapezoidal radiation pattern is output by a second diffraction slot of the second asymmetrical horn section.

24. The method of claim 23, wherein the first and second asymmetrical radiation patterns output by the first and second diffraction slots provide for wider dispersion at a bottom of an exit of the acoustic horn exit, and narrower dispersion at a top of the exit of the horn.

25. The method of claim 20, wherein the one or more first acoustic transducers are mid-frequency transducers and the first asymmetrical horn section is a mid-frequency asymmetrical horn section, and wherein the one or more second acoustic transducers are high-frequency transducers and the second asymmetrical horn section is a high-frequency asymmetrical horn section.

26. (canceled)
